(19) United States
(12) Patent Application Publication
(10) Pub. No.: US 2013/0141283 A1
(43) Pub. Date: Jun. 6, 2013

(54) METHOD FOR LOCATING A RADIO CENTER AND SYSTEM FOR LOCATING A RADIO CENTER AND DATA PROCESSING UNIT

(71) Applicants: Alexander S. Galov, Petrozavodsk (RU); Denis E. Gordeev, New York, NY (US); Alexey P. Moshchevikin, Petrozavodsk (RU); Alexey V. Solovyev, Petrozavodsk (RU)

(72) Inventors: Alexander S. Galov, Petrozavodsk (RU); Denis E. Gordeev, New York, NY (US); Alexey P. Moshchevikin, Petrozavodsk (RU); Alexey V. Solovyev, Petrozavodsk (RU)

(21) Appl. No.: 13/261,428

(22) PCT Filed: Sep. 8, 2010
(86) PCT No.: PCT/RU10/00489

§ 371 Date: Dec. 26, 2012

(30) Foreign Application Priority Data
Mar. 3, 2010 (RU) 2010107742

(51) Int. Cl. G01S 5/08

(52) U.S. Cl. CPC G01S 5/08
USPC 342/464

(57) ABSTRACT

The present invention group is related to wireless radio communication and, in particular, to devices and methods for determining the location (position) of a radio center relative to radio centers with known location. A method and a system for locating a radio center are proposed, as well as data processing unit that allows to improve the accuracy of localization by selecting minimum distance values as measured by the radio signal propagation time for the entire period of immobility of the radio center. The technical result consists of the increase of the immunity of the localization method, reducing the duration of measuring period, the possibility of locating radio centers that are heterogeneous in terms of the method being used for determining their motion.

### TECHNICAL FIELD OF THE INVENTION

The present invention group relates to wireless radio communication and, in particular, to devices and methods for determining the location (position) of a radio center relative to radio centers with known location (hereinafter—“RCKL”).

### TECHNICAL BACKGROUND

There are global navigation satellite systems (GNSS), for example, GPS and GLONASS. Location is determined based on measuring the delay of a short radio pulse propagation from the moment it is sent by a RCKL (ie. by a satellite) and until it is received by the radio center. Knowing the propagation delay (further—TOF, or Time of Flight), one can calculate the distance between them. Ideally, to determine the three-dimensional location of a mobile object, four RCKL will be needed. The drawback of the global navigation satellite systems is that satellite signals are so weak that one cannot accurately determine the coordinates inside buildings, therefore, such a system can not be used for a third-party control of radio center movements.

There are navigation methods that, to improve the accuracy of global satellite navigation systems, use additional ground RCKL (Assisted GPS (A-GPS), see Goran M. et al. <<Geolocation and Assisted GPS>>, Computer, 2001, 2:123-5). This allows to partially fix the problem of locating radio centers inside buildings.

The limitation of all global positioning systems is the high cost of equipment that provides accurate synchronization of all RCKL over time.

There are methods of radio centers' localization via ground RCKL that do not require precise synchronization of RCKL over time. In particular, methods based on measurement of the input signal strength are currently very popular (abbreviated—RSSI, or Received Signal Strength Indication, see, for example, the article by Zhang Jianwu, Zhang Lu <<Research on distance measurement based on RSSI of ZigBee>> Computing, Communication, Control, and Management, 2009, 3 (8-9):210-2).

The disadvantages of methods based on measuring the RSSI are related to the fact that the measured input signal strength is strongly influenced by propagation conditions and by method of detection of radio waves, particularly by the antennas' anisotropy in the direction of the signal, by the presence and nature of radio interference (not necessarily on the same frequency), specifics of the terrain, changes of the relative location of objects in the localization zone during measurement process (especially indoors), power supply fluctuations, changes in the atmospheric conditions during measurements, rocking of the antennas etc. (See article Eiman Elnahrawy, Xiaoyan Li, Richard P. Martin, <<The Limits of Localization Using Signal Strength: A Comparative Study>> IEEE SECON, October 2004) The presence of these factors results in unpredictable fluctuations in the radio signal strength (see ibid.) A typical curve representing the dependence of measured RSSI from the true shortest distance between the radio centers is shown in FIG. 1 as dotted line, which, as indicated, is located above the RSSI₁ that corresponds to the limit of sensitivity of RCKL (vertical lines are showing confidence intervals). As follows from FIG. 1, it is impossible to determine the distance between the radio stations even based on the exact instantaneous value of the radio signal strength (eg., based on the level of RSSI₂). This disadvantage is compounded by the fact that modern equipment is characterized by inaccurate discretization of measurements and by narrow dynamic range, so it does not allow to measure the signal strength with desired accuracy.

There are methods of radio center localization via ground RCKL that do not require accurate synchronization. These methods are based on the accurate measurement of signal propagation time between at least three ground RCKL and the radio center (Time of Flight, or TOF).

In particular, the well-known method of measuring distances by RTT (Round Trip Time) measures the TOF during propagation of the radio signal from one radio center to another, and then in the opposite direction (see Gogolev A. Ekimov D., Ekimov K., Moschevikin A., Fedorov A., I. Tsykunov I. <<The accuracy of distance measurement using nanoLoc technology>> Wireless Technology, 2008, 2:48-51). As shown in FIG. 2, radio center 1 transmits to radio center 2 the first radio signal containing a request for measurement (package <<DATA>>) and captures the time of transfer; after receiving the first radio signal, radio center 2 immediately sends to radio center 1 the second radio signal (package <<ACK”), and finally, radio center 1 records the time of the reception of the second signal. Considering the time of signal processing by both radio centers to be the same, the signal propagation time tₚ is usually calculated using the following formula:

tₚ=(Tᵣₑₛₚₒₙₛₑ−T_{processing})/2

where Tᵣₑₛₚₒₙₛₑ is time measured by radio center 1 from the moment of transmission of the first signal until the moment it received the second signal, T_{processing} is the time measured from the moment the two radio centers received the first signal and until the time of transmission of the second signal. The distance between these radio centers is calculated based on known velocity of radio signal propagation.

The limitation of this method is that the measurement accuracy is reduced due to the inability to compensate for the difference between speeds of clocks (clock drift) that are used by the radio centers (see the above-mentioned article by Gogolev A.).

In the U.S. published patent application number 2009/00253439, to overcome this limitation, the aforementioned session of RTT's determination is executed twice. First, as shown in FIG. 3, the measurement session is initiated by radio center 1, and after that—by radio center 2, after which average time of signal propagation is calculated. This method is called Symmetric Double-Sided Two-Way Ranging (SDS-TWR, for more details, please see the above-mentioned article by Gogolev A. et al.)

Although the accuracy of methods using TOF (RTT, TWR, SDS-TWR) is independent of factors contributing to the aforementioned radio signal strength fluctuations, their limitation is that, due to non-linearity of signal propagation (eg., due to multiple reflections from walls or from the ground surface), the measured distances are always longer than the shortest distance between the RCKL and the radio center.

Other methods of radio center localization by ground RCKL that do not require exact synchronization of RCKL using RSSI and/or TOF measure the distance between the radio center and at least one RCKL and simultaneously determine the direction of the radio signal from the radio center (AOA, or Angle of Arrival, and DOA, or Direction of Arrival).

In particular, there is a method of radio center localization that measures the distance between the radio center and the RCKL using TOF, and the direction of radio signal reception by RCKL—using AOA (U.S. Pat. No. 5,719,584). The limitation of this method is lack of precision in the existing equipment to measure the AOA.

Overestimation of measured distances between radio centers is a common problem with methods based on TOF and RSSI, the only difference being that TOF values by definition cannot be less than the shortest distance between radio centers, whereas instantaneous RSSI values can be either higher or lower than the true ones, and accuracy of distances calculation is not improved by the accumulation of instantaneous strength values (see article Elnahrawy E., Xiaoyan Li, Martin R. P. <<The limits of localization using signal strength: a comparative study>>, Sensor and Ad Hoc Communications and Networks, 2004, ISBN: 0-7803-8796-1).

There are various ways to improve the accuracy of localization in conditions of non-linear signal propagation.

To improve the accuracy of localization, distances are measured repeatedly in the first group, and the obtained series of measurements are treated using various statistical methods.

There is a method of radio center localization, which increases the accuracy by filtrating obviously excessive measurements through histograms; in addition, the results can be improved by the method of least squares with weight ratios applied, with the assumption that the radio center moves steadily (U.S. Pat. No. 7,383,053). The problem that prevents achieving the technical results mentioned below with this method is that it requires high-frequency measurements for each distance (about 1000 Hz), which overloads the airwaves and leads to high power consumption by the radio center. This system is not suitable for simultaneous localization of a large number of radio centers over a long period of time without recharging.

There are methods of radio center localization that filter exaggerated measurements by using the empirical function of probability density that is generated based on the previously conducted experiments (European patent applications numbers 2092364 and 1605725). The limitation of these systems that prevents achieving the technical result mentioned below is that they require time and labor consuming preliminary calibration.

To improve the accuracy of localization in the second group of methods, individual limitations of RSSI and TOF methods are compensated by combining them.

There is a method of radio center localization, which checks the location of the radio center in the direct line of sight of a RCKL, and if the center is in the direct line of sight, the distance from the radio center to the RCKL is measured by TOF (European Patent application number 1469685). The disadvantage of this method that prevents achieving the technical result mentioned below is that, due to strength fluctuations, the strong signal does not always mean that the radio center is actually in the line of sight of the RCKL. Another limitation that prevents achieving the technical result mentioned below is that the measurement of distances by TOF method in the conditions of the direct line of sight does not preclude overstating the results due to the radio signal reflection. For example, when the radio center is located indoors, even in the direct line of sight conditions, the measured distances may be higher due to the reflection of the radio signal from the walls.

There are methods of radio center localization that combine RSSI and TOF approaches, and the nonlinearity of the signal propagation effect on the accuracy is offset using previously compiled maps of signal strength (European patent application number 2092364 and the international application No. WO/2007/129939 A1 publication). The disadvantage of these methods that prevents achieving the technical result mentioned below is in the fact that they do not account for the strength fluctuations caused by changes in the relative location of objects within the localization zone. Another problem with these methods that prevents achieving the technical result mentioned below is labor intensity of preparing these maps. To improve accuracy of localization in the third group of methods, TOF and/or RSSI values are processed based on the information about the object's movement.

There is a method of radio center localization, where its initial location is determined by RSSI, and the distance over which the radio center has moved from the original location is determined taking into consideration the data on its acceleration along multiple axes (international publication number WO/2007/129939 A1).

There is a method of radio center localization, where a series of RSSI measurements are subjected to averaging only if the radio center was stationary during the measurement (U.S. Pat. No. 7,042,391). The disadvantage of this method that prevents achieving the technical result mentioned below is that the averaged results of a small number of serial measurements are strongly influenced by fluctuations.

The common problem of the aforementioned third group of methods, which prevents achieving the technical result mentioned below, is that with vibrations, as well as with steady and rectilinear motion of the radio center, the use of data about acceleration causes serious errors in the localization.

Thus, the known methods do not ensure radio center localization with accuracy of 1 to 3 meters in conditions of considerable screening of the radio signal, in conditions of non-linear signal propagation, and/or when relative positions of objects in the area of localization are changing.

### SUMMARY OF THE INVENTION

The present invention group is related to wireless radio communication and, in particular, to devices and methods for determining the location (position) of a radio center relative to radio centers with known location.

A method and a system for locating a radio center are proposed, as well as data processing unit that allows to improve the accuracy of localization by selecting minimum distance values as measured by the radio signal propagation time for the entire period of immobility of the radio center.

Technical result is the increase of immunity of the localization method, reduction of the measuring period's duration, and possibility of locating radio centers that are heterogeneous in terms of method being used for determining their motion.

### DISCLOSURE OF THE INVENTION

The group of claimed inventions solves the problem of increasing the accuracy of radio center's localization using radio signal propagation time between the radio center and radio centers with known locations in conditions of non-linear signal propagation, and/or when objects are changing their relative positions in the localization zone (ie., the problem of increasing noise immunity).

At the same time and additionally, it solves the problem of speeding up location verification, thereby reducing the time period of measurement.

At the same time and additionally, it solves the problem of the exact localization of radio centers that are heterogeneous in the method used for determining motion.

These tasks are solved thanks to the fact that, using the method of radio center localization by measuring the distances between the said radio center and radio centers with known locations (RCKL) by the signal propagation time between them (TOF)

parameters of movement of the said radio center are measured,

radio signal strength from the said radio center is measured,

displacement of the radio center with the preset speed limit is calculated for the period of time between localization points,

accuracy of localization is calculated depending on the size of the overlapping area of circles with centers in these RCKL and radii that are equal to the measured distance between them and the said radio center,

these parameters of movement and change in the radio signal strength are compared with predefined threshold values, and the said displacement—with the said localization accuracy and

location is calculated while taking into account minimum distance measured over the whole period of immobility, during which these movement parameters and changes in the said strength are less than the said threshold values, and the said displacement is less than the said accuracy of localization.

Unexpectedly, it has discovered that, when using data on acceleration of the radio center in conjunction with the information on changes in the radio signal strength, it becomes possible to recognize linear movement of the radio center and radio center's movement with acceleration and/or speeds below a preset threshold value. This allowed overcoming the drawback of the localization method that was known from the above mentioned U.S. Pat. No. 7,042,391. Another distinctive feature of the claimed method is that the accuracy of localization is not affected by radio signal strength fluctuations, because, instead of measuring RSSI, the location is determined by the radio signal propagation time. As a result, one can use the input signal strength variation instead of absolute values of RSSI.

Simultaneous measurement of acceleration and signal strength provides accurate localization even for centers that are not equipped with instruments that measure speed or displacement. This also allows to use the system for localization of heterogeneous radio stations, some of which can be equipped only with acceleration measuring instruments (such as accelerometers) and others—only with speed and/or displacement measuring instruments (eg, speedometer, tachometer, odometer and/or frequency shift sensors).

But most importantly, it was unexpectedly discovered that, if only the minimum absolute value in the sequence of reference distances between the RCKL and a stationary radio center is used for localization calculation, all other things being equal, the time to achieve the desired localization confidence interval will be several times less than when measuring the radio signal strength. This reduces the frequency of measurements, reduces energy consumption, frees up the airwaves and increases accuracy of recording the moving object's track, as compared to the localization method described in the above-mentioned U.S. Pat. No. 7,042,391.

If R+dR₁, R+dR₂, . . . , R+dRₙ is a series of N measured reference distances between the radio center and the RCKL, where R is true value of the distance, dRᵢ—i-th error of measurement, and dRₘ—the minimum error, then the average value according to U.S. Pat. No. 7,042,391 will be:

Rcp=(R+dR₁+R+dR₂+ . . . +R+dRₐ)/N=R+(dR₁+dR₂+ . . . +dRₐ)/N.

The claimed method chooses the minimum value of the measured distance from the RCKL to an immobile radio center, and hence the minimum error dRₘ. Therefore, the distance between the stationary radio center and the RCKL, as calculated for N measurements, corresponds to the formula

R+dRₘ

It is obvious that:

R+(dR₁+dR₂+ . . . +dRₙ)/N>R+dRₘ

Thus, the presented method overcomes the fundamental limitations of accuracy that are inherent in methods based on the statistical processing of data on the radio signal strength and the radio center's acceleration, because the location for the radio center, as calculated on the basis of N measured reference distances from the radio center to the RCKL, instead of averaging all of the data that each contains an error, chooses the single most precise measurement of all N measurements.

It should be understood that instruments for measuring the radio signal strength can be located inside the radio center or inside the RCKL. When strength measuring instruments are located inside the radio center, the parameters of the radio signal strength are transmitted to the processing unit through a wireless telecommunication channel.

The hardware design and placement of instruments that measure motion parameters depend on their type. Thus, if magnetometers, accelerometer with inertial mass, speedometer, odometer or tachometer are used to measure the motion parameters, these instruments should be made in such a way that would allow the radio station to move with them. If measurement of motion parameters (eg, velocity and/or acceleration) is carried out using the Doppler shift, it is preferable to place the frequency difference sensor inside the RCKL. If the frequency difference sensor is placed inside the radio center, the parameters of frequency shift are then transmitted to the processing unit through a wireless telecommunication channel.

Radio center may be further equipped with instruments to control the displacement and/or direction of movement, such as magnetometer (in particular, the magnetic compass), accelerometer that will measure the acceleration along multiple axes, gyroscope and odometer. These instruments allow tracking the path of the object from a point with known location, which can be used to reduce the number of measurements in the claimed method and to free up the airwaves.

It should be understood that to implement this method it is necessary for the distance between the radio center and a certain RCKL (eg, signal propagation time between RCKL and radio centers or distance in meters), the parameters of the radio signal strength (for example, the absolute value of strength, or its variation within a given period of time), and motion parameters to be broadcast into a unified information environment, and to be jointly taken into account during calculations of the location and of accuracy of the location. This can be achieved, in particular, through the transmission of data in digital form through telecommunication channels of wired and/or wireless networks. In order to synchronize, the radio centers can read each type of this data at equal intervals, or at varying intervals, but then data is tagged for later processing, allowing to combine the results by the time they were received.

Analysis of measurements can be performed by various components of the system—by radio centers themselves, inside RCKL, or by specialized equipment.

To measure the distance between the radio center and RCKL, various modifications of TOF method are suitable.

In a particular case of implementation, the distance between the radio center and RCKL is measured by the symmetric double-sided two-way ranging (SDS-TWR).

In another particular case of implementation, the distance between the radio center and RCKL is measured by RTT method.

In yet another particular case of implementation, earlier located radio centers are being used. This may allow to obtain the location of objects even when the radio center is out of coverage that is provided by a stationary RCKL, as well as when the accuracy of measurements between previously positioned radio centers is higher than measurement accuracy between the radio center and the stationary RCKL.

Depending on available data on limitations of the radio center's mobility, an accurate location may require a varying number of RCKL.

In a particular case of implementation, the distance is measured to at least one RCKL. The exact location is then determined based on the trajectory data that the radio station cannot deviate from due to certain limitations. In particular, if it is known that the radio center moves on railroad tracks or along a known path, its location can be determined with confidence by measuring the distance to a single RCKL.

In a particular case of implementation, the distance is measured to at least to three RCKL that are located at a distance from each other. This allows determining the radio center's location by known methods of triangulation.

The accuracy of localization depends on the size and/or the area of overlapping portions of circles with centers in RCKL and radii that are equal to measured distances. In this case, the more RCKL are used for localization, the smaller, as a rule, is the area of this figure, and, consequently, the higher is accuracy. However, to free up the airwaves, it is preferable to minimize the number of RCKL needed to achieve the desired accuracy of localization. To achieve the balance between accuracy of localization and the usage of airwaves, it is preferable to try and achieve the required localization accuracy using the minimum number of RCKL.

In a particular case of implementation, with the above mentioned location accuracy below a preset value, the distance between the said radio centers and several additional RCKL is measured.

In another particular case of implementation, a certain number of RCKL is used that is sufficient to achieve a pre-determined accuracy of localization.

To select several additional RCKL, various criteria can be used. As a rule, the probability that a RCKL will help improve the accuracy of localization will be that much higher, the smaller is the distance between it and the radio center.

In a particular case of implementation, multiple RCKL used were selected while taking into consideration radio signal strength from the said radio center.

Alternatively or additionally, distances are measured between the radio center and all or several additional RCKL that cover that radio center, and the additional RCKL are arranged according to strength of their impact on the accuracy of localization. Then, additional RCKL are added in the order of decreasing strength of their influence on the accuracy of localization.

In a particular case of implementation, the RCKL used were selected by comparing the strength of their influence on the localization accuracy of the above mentioned radio center.

Radio center location is calculated using the distance between the radio center and the RCKL based on various algorithms.

In a particular case of implementation, the location is calculated as a geometric locus of an internal point in the overlapping area of circles with centers in these RCKL and radii that are equal to the measured distances between them and the said radio center.

In one particular case of implementation, the location is calculated as the geometric locus of an internal point that is equidistant from the boundaries of the said area.

In another particular case of implementation, the location is calculated as the geometric locus of an internal point that is a provisional center of mass of the said area.

In yet another particular case of implementation, the above-mentioned area is determined while taking into account the distance that was pre-adjusted depending on the signal strength. This allows to use the advantages of RSSI measurements in those cases, where they do not disagree with measurement results by TOF method.

Accuracy of measurements can be further improved by eliminating from these overlapping areas such points where the radio station clearly cannot be located, for example, steep mountain slopes, fenced areas or parcels of land that are located away from the road for radio centers that are moving along highways or railroads, or inaccessible portions of buildings.

Thus, in one particular case of implementation, to calculate the location of the said circles overlap area, some pre-defined areas, where the radio center cannot be located, were excluded.

To determine the displacement of the radio center, various instruments can be used.

In a particular case of implementation, measurements of the said parameter of the radio center's movement were performed by a magnetometer, accelerometer, odometer, tachometer and/or speedometer.

One of the preferred methods is the measurement of the radio center's movement parameter is carried out using Doppler radio signal frequency shift.

To reduce the number of RCKL needed to localize with a given accuracy, one can use the information about the direction of radio signal propagation, such as information about the phase difference of the radio signal that is emitted in the vicinity of closely positioned antennas.

Thus, in one particular case of implementation, to determine the direction of radio signal propagation, the difference of phases of the radio signal from the radio center is measured.

To measure the distance between the radio center and RCKL, to determine the strength of the radio signal, and to transmit information, either various single-frequency and multi-frequency radio signals can be used, or a single single-frequency or multi-frequency signal.

The lowest usage of airwaves is achieved by measuring the distance and strength using a single radio signal. Even lower usage of airwaves is achieved by measuring the distance, strength and by transmitting data using a single radio signal.

To implement the method described above, various automated systems can be used, including radio centers with a known location and radio centers, the location of which it is necessary to determine, as well as telecommunication equipment that is required to broadcast the results of these measurements and calculations into a single information environment, and equipment of analog and/or digital processing of the measurement results.

Another result of the proposed invention is a system of radio center localization, which solves the stated above problem of increasing the accuracy of localization by containing the following:

radio centers with a known location (RCKL),

time meter (TM) for signal propagation between the RCKL and the said radio centers by signal propagation time between them,

distance calculator (DC) between the RCKL and the said radio center that is connected to the said DC,

location calculator (LC) of the said radio center taking into account the distances between the RCKL and the said radio center,

accuracy calculator (AC) of the said radio center locations, depending on the area of the overlapping circles with centers in RCKLs and radii equal to the distances between the radio center and RCKL,

movement calculator (MC) of the said radio center with the preset speed limit for the period of time between consecutive localization points,

meter of movement parameters for the said radio center (MMPR)

meter of the radio signal strength parameters (MS) of the said radio center,

first comparator (FC) connected to the MMPR and configured to compare changes in the input value with a predetermined threshold value,

second comparator (SC) connected to the MS and configured to compare changes in the input value with a predetermined threshold value,

third comparator (TC) connected to the MC and AC and configured to compare the input values to each other,

memory device (MD),

forth comparator (4C) connected to the DC and configured to compare changes in the input value with the MD value,

first logical calculator (FLC), with the option to compute the Boolean function “NOR”,

second logical calculator (SLC), with the option to compute the Boolean functions “AND”,

recording unit (RU) configured to record the distances between RCKL and the said radio center in the MD,

in which

FC, SC and TC outputs are connected to the FLC input, FLC output and 4C output are connected to the SLC input, and SLC output is connected to the RU.

The system can be additionally equipped with instruments to monitor and improve the accuracy of localization.

In the particular case, the system further contains a fifth comparator (5C) that has the ability to compare the accuracy of the said localization with a predetermined threshold value, and the sixth comparator (6C) with the ability to compare the influence of the above mentioned RCKL on the said localization accuracy, as well as the control unit (CU) configured to activate as many RCKL as necessary to ensure the accuracy of localization above the said threshold.

Functional elements of the system can be already known elements that are connected together according to certain rules. Any general purpose or specialized analog and/or digital processors, controllers, micro-controllers and/or reconfigurable systems can be used.

In a particular case, at least two of the LC, DC, AC, MC, FLC, SLC, FC, SC, TC, 4C, RU, 5C, 6C, CU are arranged into a single integrated circuit. In this case, these elements can be implemented on the basis of known operational amplifiers, resistors and capacitors that are connected to each other according to certain rules.

Functional elements of the above system can be implemented as hardware or firmware, containing in the hardware part the already known general purpose processors (eg, with RISC, MISC or CISC architecture), ASIC-processors, DSP-processors, programmable logic integrated circuits (PLIC) and/or electronic analog computing.

In the particular implementation, at least one of the LC, DC, AC, MC, FLC, SLC, FC, SC, TC, 4C, RU, 5C, 6C, CU was made on the basis of at least one general purpose processor, ASIC-processor, DSP-processor, programmable logic integrated circuit (PLIC) and/or electronic analog computing device.

When different functional elements or groups of functional elements of the system are located far from each other, such as some of the elements in RCKL, and others are in a central server, it is necessary to transmit the results of measurements and calculations into a single information environment.

In the particular implementation, RCKL and LC, DC, AC, MC, FLC, SLC, FC, SC, TC, 4C, RU, 5C, 6C, CU are linked by a single wired and/or wireless network.

Various instruments are suitable for measuring the movement parameter of the radio center.

In one particular implementation, the MMPR is a magnetometer, accelerometer, odometer, tachometer and/or speedometer.

In another particular implementation, the MMPR is based on the meters of the Doppler shift.

Another result of the proposed invention is a data processing unit for the implementation of the radio center localization method, which solves the above stated problem of increasing the accuracy of localization by containing the following:

telecommunications interface (TI) for receiving motion parameters of the said broadcasting center, parameters of the said radio center radio signal strength, and parameters of the distance between the said radio center and the radio center with known location (RCKL),

locations calculator (LC) of the radio center within the parameters of the distance between the radio center and RCKL,

accuracy calculator (AC) of the said radio center locations, depending on the area of the overlapping circles with centers in RCKLs and radii equal to the distances between the radio center and RCKL,

movement calculator (MC) of the said radio center with the preset speed limit for the period of time between consecutive localization points,

first comparator (FC) configured to compare the said parameters with predetermined threshold values,

second comparator (SC) configured to compare the said radio signal strength parameters with predetermined threshold values,

third comparator (TC) connected to the MC and AC and configured to compare the input values to each other,

memory device (MD),

forth comparator (4C) connected to the DC and configured to compare changes in the input value with the MD value,

first logical calculator (FLC), with the option to compute the Boolean function “NOR”,

second logical calculator (SLC), with the option to compute the Boolean functions “AND”,

recording unit (RU) configured to record the parameters of distances between RCKL and the said radio center in the MD,

in which

FC, SC and TC outputs are connected to the FLC input, FLC output and 4C output are connected to the SLC input, and SLC output is connected to the RU.

The same way as described for the above system, in a particular case of implementation, at least two of the LC, DC, AC, MC, FLC, SLC, FC, SC, TC, 4C and RU are arranged into a single integrated circuit.

In another particular case of implementation, at least one of the LC, DC, AC, MC, FLC, SLC, FC, SC, TC, 4C and RU was made on the basis of at least one general purpose processor, ASIC-processor, DSP-processor, programmable logic integrated circuit (PLIC) and/or electronic analog computing device.

In another particular implementation, RCKL and LC, DC, AC, MC, FLC, SLC, FC, SC, TC, 4C and RU are linked by a single wired and/or wireless network.

In yet another particular case of implementation, the assembly further includes a distance calculator (DC) between RCKL and the said radio station.

It is necessary to understand that the objects of the above-described group of inventions may contain all or just some of the above-mentioned particular and preferred implementations or executions, provided that they do not exclude each other, and that these combinations of features are also included in this disclosure.

An average expert, after considering descriptions of similar inventions and the technology level, should be able to understand the functions and possible options of execution, connection and location of the above mentioned functional elements; for example, it should be clear that the comparator can be implemented on the basis of operational amplifiers, or on the basis of hardware and software combination, such as general-purpose computers that are equipped with software that provides data comparison.

If any of the structural components and other features that are known to an average specialist are necessary for the practical implementation of the presented inventions, but are not specifically mentioned in the invention formula and are not disclosed in the description, then they are immanent and their particular implementation is well known from analogues and the technology level.

The presented group of inventions can be used to control the localization and movement of staff inside a production area (either in real time, or on reducible basis).

For a better understanding of invention's ideas, some illustrating drawings are given below, showing some particular implementations of the invention's elements or of the method, the main elements that are present, their location and connection, as well as some details of methods' implementation. However, despite the fact that the invention is described herein with reference to positions of elements shown in the drawings, one should not attribute their features to the corresponding elements, which are referenced in the text.

### BRIEF DESCRIPTION OF DRAWINGS

FIG. 1 shows a typical graph of the radio signal strength measurements (RSSI) relationship to the true shortest distance between the RCKL and the radio station.

FIGS. 2 and 3 are timing diagrams illustrating the method of measuring distances RTT (TWR) (FIG. 2) and by SDS-TWR (FIG. 3).

FIG. 4 is a diagram showing how the distance refinement helps to improve the localization results.

FIG. 5 is a diagram illustrating how accumulation of data helps to improve the localization results of an immobile object.

FIG. 6 schematically shows the typical system structure for determining the location of the radio center.

FIG. 7 is a diagram illustrating the operation of determining the localization accuracy.

FIG. 8 is a diagram illustrating the position, where the radio station is outside of the polygon.

FIG. 9 is a diagram illustrating the positioning point by computing the geometric locus of a point that is equidistant from circles that were adjusted for error.

FIG. 10 is a diagram illustrating operation of the radio center trajectory smoothing using the least squares method.

FIG. 11 shows the functional components and connections of the presented localization system.

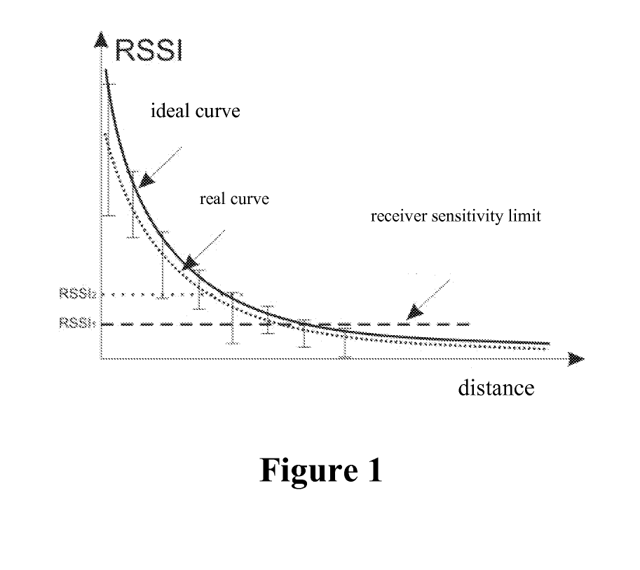

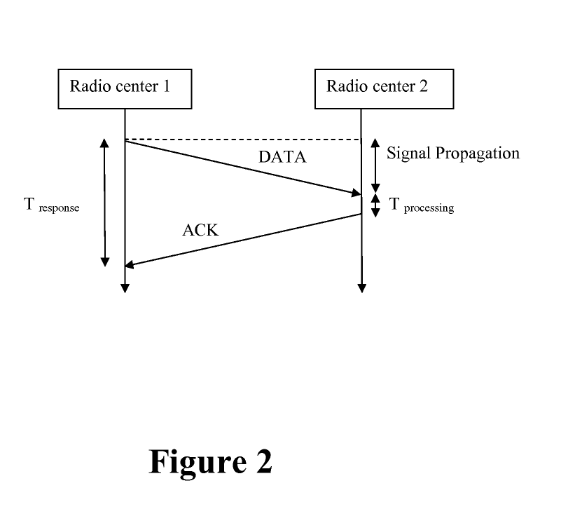

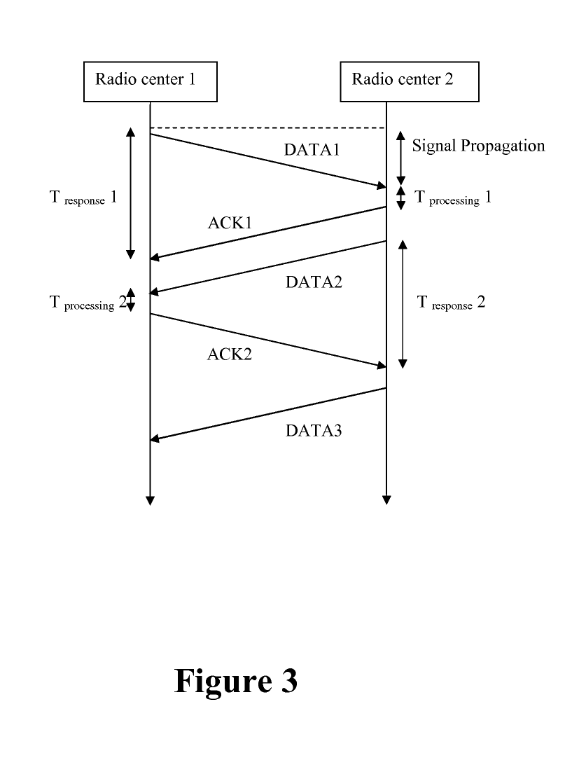

### INVENTION IMPLEMENTATION

The following description of particular implementations is given only to illustrate the concept of the invention. Nothing in this section of the description should be construed as limiting the scope of claims. It should be understood that an average expert, who is familiar with the ideas of the present invention, may use its general features and make equivalent substitutes to achieve the objective without departing from the spirit and scope of this invention.

### Example 1

The method is implemented as follows: during the measurement period, the distance between the radio center and radio centers with known locations (RCKL) is measured by radio signal propagation time between them (for example, by the method of RTT, TWR and/or SDS-TWR),

at the same time, parameters of movement of the said radio center are measured (eg, acceleration, velocity or displacement),

at the same time, the radio signal strength parameter from the said radio center is measured (for example, the radio signal strength is measured that is coming to the multiple RCKL that are used to measure the signal propagation time),

after that the displacement of the radio center with the preset speed limit is calculated for the period of time when readings were taken (time between locations),

accuracy of localization is calculated depending on the size of the overlapping area of circles with centers in these RCKL and radii that are equal to the measured distance between them and the said radio center (for example, according to example 5),

these parameters of movement and of the said signal strength (eg, for the time period of readings) is compared with pre-defined threshold values, and the said displacement—with the said accuracy of localization (for example, using the system described in example 2) and

location of the said radio center is calculated, while taking into account the minimum distances, as measured over the whole period of immobility, during which these movement parameters and changes in the said strength parameters are less than the said threshold values, and the said displacement is less than the said accuracy of localization.

Improvement of accuracy of locations by choosing the least measurements over the entire period of immobility of the radio center is shown in example 3.

### Example 2

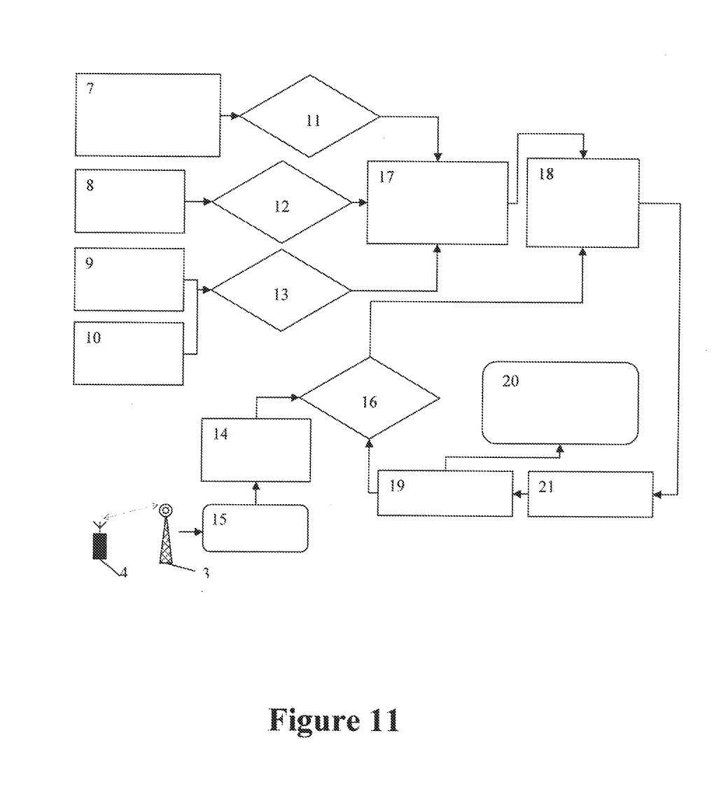

Radio center localization system, as shown in FIG. 11, works as follows.

the RCKL (3) and radio centers measure radio signal propagation time using the TM and one of the TOF methods. Using the known radio signal propagation time and TM (14), the distance between the radio center and RCKL (3) is calculated. The overlapping area is calculated for the circles with centers in the RCKL (3) and radii equal to the calculated distance; then, the localization precision is calculated according to a predetermined by the TM (10) correlation. Possible locations of the radio center are calculated taking into account the distances computed by the LC (20). Possible displacement of the radio center is calculated using the MC (9), given its preset speed limit and the length of time between successive localization points. Parameters of the object's motion are calculated by MMPR (7) (eg, magnetometer, accelerometer, speedometer, odometer, tachometer). Radio signal strength from the said radio center is measured using the MS (8). The radio center's movement parameter is compared with a predetermined threshold value using the FC (11). The radio signal strength measurement is compared with a predetermined threshold value using the SC (12). The calculated displacement is compared with the calculated localization precision using the TC (13). The calculated distances are compared with the calculated distance from the MD (19) using the 4C (16). The logical function “NOR” is calculated using FLC (17), which takes the “true” value, if any of the object's motion parameters or the change in the signal strength is not above the threshold values and the calculated displacement is below the calculated measurement accuracy. The logical function “AND” is calculated using the SLC (18), which takes the “true” value, if the calculated distance is less than the calculated distance in the MD (19) and the said logical function “NOR” is set to “true”. The calculated distance is recorded in the MD (19) using the RU (21), if the said function “AND” is set to “true”.

If the FLC output (17) appears as “false”, for example, when the output of any of the comparators FC (11), SC (12) or TC (13) is set to the “true” value, the whole measurement procedure is repeated. In this case, the system does not perform the refinement of measurement with the passage of time (as the object moves), and localization points are calculated using the current values of distances.

### Example 3

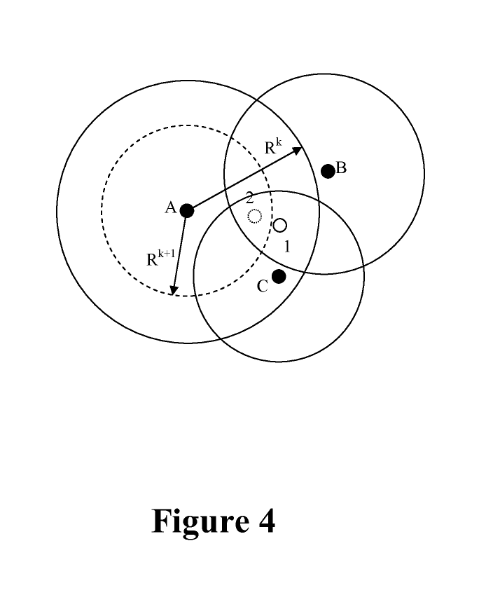

FIG. 4 clearly shows how the accumulation of localization points of an immobile radio center can improve accuracy. Black dots indicate points, whose location is known in advance (A, B and C), circle number 1 is the estimated location of the mobile center after the first cycle of measurements (in the area of the overlap of all three circles), circle number 2 is the corrected location of the mobile center after adjusting the radius from center A (the corrected radius is shown by the dashed line).

When speed and/or acceleration of the radio center and change of the radio signal strength are below the threshold, the minimum value is selected (R+dR)min from a series of consecutive values for each pair—radio station/RCKL:

R+dR₁,R+dR₂, . . . ,R+dRₙ,

where dRᵢ is the overestimation of the i-th measurement of the true distance R

of the measured distances between the radio center and the RCKL for the radio center immobility period. Since the true distance between the immobile centers R=const, then R+dR is minimal when the overstatement dR is minimal.

As shown in FIG. 4, if the next measurement of the distance between the immobile radio center and RCKL B and C gives the same results as the previous measurement Rₖ, and a much smaller distance (Rₖ₊₁) is received from center A, then, after correcting calculations, the estimated location of the radio center has moved to point 2, and the area of the circles overlap has decreased, therefore, the localization accuracy has increased.

### Example 4

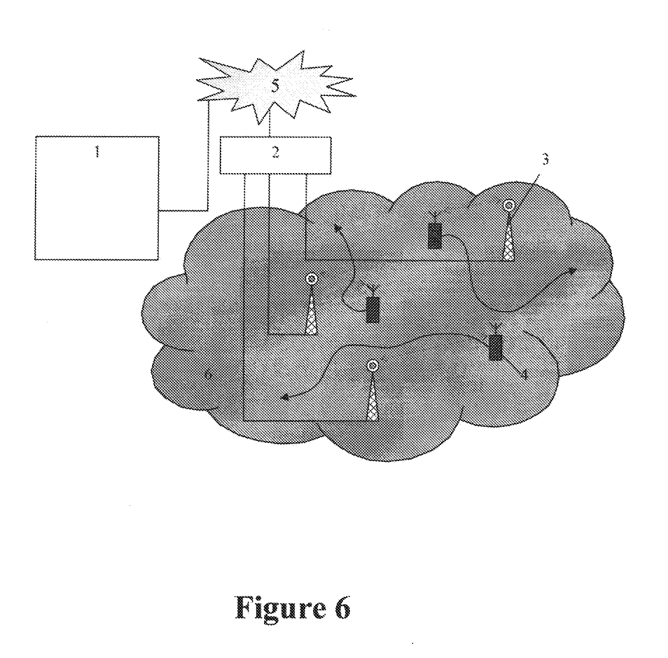

In one particular case of implementation, the presented method is used with the system containing radio centers, RCKL and the controls and data processing equipment (CDPE), as shown in FIG. 6, where positions 1-6 indicate the following: controls server, switching, data acquisition and processing (1), the switch (2), RCKL (3), radio center (4), the World Wide Web (5) and coverage area of RCKL (6).

Radio centers may occasionally leave the state of low power consumption and transmit a radio signal that is received by many RCKL, which cover the area where the radio center is located. RCKL are connected into a single information environment through wired or wireless telecommunications network. Radio signals' data is transmitted over the said network to the said CDPE.

CDPE selects a RCKL and starts the process of distances measurement by the presented method using the selected RCKLs (applicable for the radio center in question). During this, the first radio center comes out of low power consumption mode (by timer or by pressing a button), transmits a radio signal indicating willingness to continue working (datagram “I woke up”), sends and receives radio signals related to the measurement of distances by the presented method for a specified period of time, and returns into the low power consumption mode after the measurements are done. During operation, these RCKL perform continuous reception of the above mentioned radio signals “I woke up” from all radio centers located within the coverage area, continuously receive and transmit radio signals related to the measurement of distances by the presented method only to and from the radio centers, for which they are applicable, and broadcast the received signals “I woke up” data and the results of measurements and/or calculations to a single information environment for CDPE. CDPE receive data on the receipt of the above mentioned radio signals “I woke up,” collect measurements and/or calculations, and, based on them, calculate the radio center's location and keep the localization points in the database, if necessary. The choice of RCKL that is applicable to a certain radio center can be made by the radio signal strength or by how much the RCKL affects the accuracy of localization.

The system allows determining the radio center location both indoors and in the outside areas where the RCKL are installed, in both linear and non-linear signal propagation conditions.

### Example 5

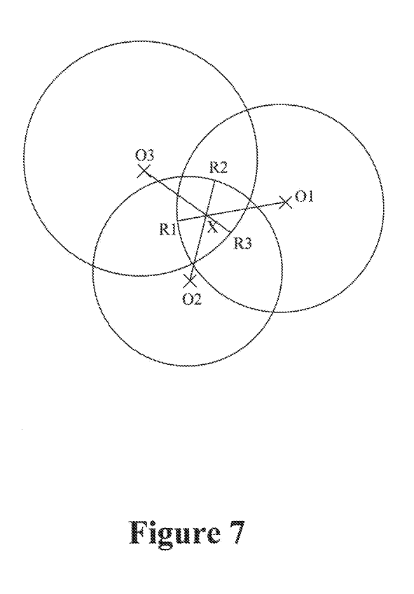

In one case of the presented method implementation, as shown in FIG. 7, to calculate the accuracy of localization, the measured distances are presented as circles, the centers of which are RCKL and the radio station has be positioned in their overlapping area. To assess the accuracy of localization, the location of the radio center (point X) is chosen equidistant from the arches that form the area of localization. If no such point exists (it is possible, particularly, if the area is formed by four or more overlapping circles), the radio center's location is chosen so that the difference between the segments XRᵢ−XRⱼ was minimal (ie Σ_{i≠j}(XRᵢ−XRⱼ)=min). As shown in FIG. 7, the average difference of segments OᵢRᵢ—OᵢX is chosen as an estimate of the localization accuracy, where n is the number of circles that form the area of localization (for example, for the situation shown in FIG. 7, the accuracy of localization Acc is estimated as Acc=(O₁R₁—O₁X+O₂R₂—O₂X+O₃R₃—O₃X)/3).

### Example 6

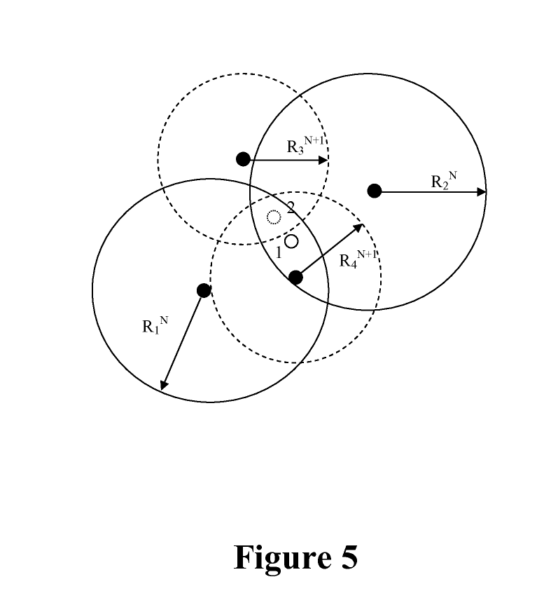

FIG. 5 clearly shows how the increase in the number of RCKL allows for more accurate localization of an immobile radio center.

If, during the implementation of the presented method, at the moment of time N, the distances to k of RCKL were measured, and at the next moment of time N+1, the distances were measured to other j of RCKL, then the location based on k+j values of distances between RCKL can be calculated for the period of radio center's immobility.

### Example 7

Radio center's coordinates and corresponding localization accuracy can be collected in a chronological order and used as a basis to approximate the trajectory of the radio center's movement.

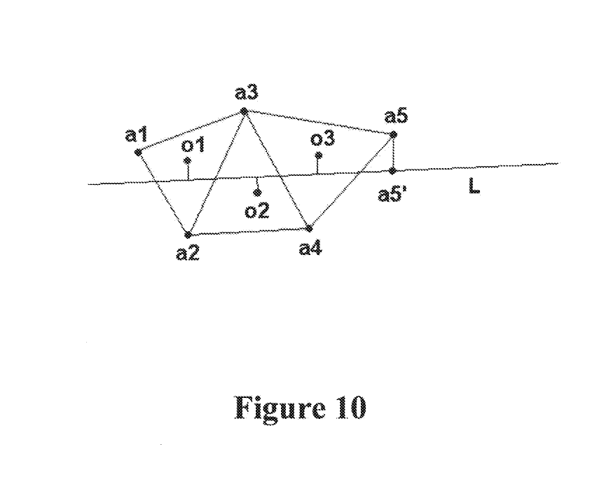

To reduce the errors of the localization, several successive positions can be averaged, and for even more accurate averaging it is possible to use the coordinates of the points with a ratio that is proportional to the localization accuracy Acc (Acc value determination is shown in example 6). As shown in FIG. 10, the trajectory can be further flattened by known methods, eg, using the method of least squares.

Let's consider points a1, a2, a3, a4 and a5, which are positions of the radio center in chronological order, where a5 is the current location with coordinates of the center X5, Y5 and radio Acc5 describing the localization accuracy. For each combination of three points (a1, a2, a3), (a2, a3, a4), (a3, a4, a5) and taking into account sets of accuracy radios (Acc1, Acc2, Acc3), (Acc2, Acc3, Acc4), (Acc3, Acc4, Acc5) (the mechanism is described above), the geometric locus of points o1, o2, o3 is determined by averaging (coordinates Xₒᵢ, Yₒᵢ for each point o1, o2, o3).

Xₒᵢ=(1/Accᵢ)Xₐᵢ+(1/Accᵢ₊₁)Xₐ₍ᵢ₊₁₎+(1/Accᵢ₊₂)Xₐ₍ᵢ₊₂₎)/(1/Accᵢ+1/Accᵢ₊₁+1/Accᵢ₊₂),

Yₒᵢ=(1/Accᵢ)Yₐᵢ+(1/Accᵢ₊₁)Yₐ₍ᵢ₊₁₎+(1/Accᵢ₊₂)Yₐ₍ᵢ₊₂₎)/(1/Accᵢ+1/Accᵢ₊₁+1/Accᵢ₊₂),

where i is the integer 1, 2 or 3

Points o1, o2, o3 are chosen as positions of the radio center, or they are approximated by their line L using, for example, the method of least squares.

### Example 8

To calculate the location of the radio center in the area of localization, the presented method can use various approaches.

Normally, the coordinates are obtained by averaging the coordinates of circles' intersection points that form the overlapping area. For a more precise location, coordinates of circles' intersection points can be averaged with ratios that are dependent on the strength of the radio signal.

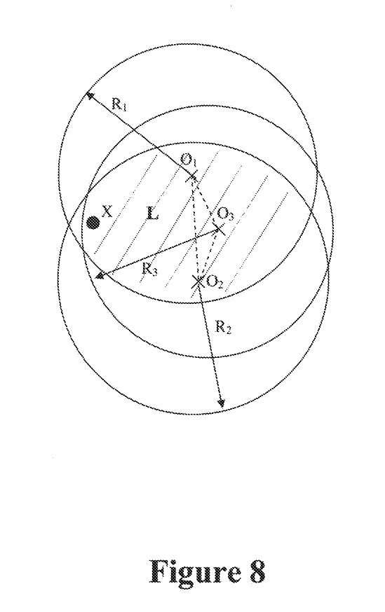

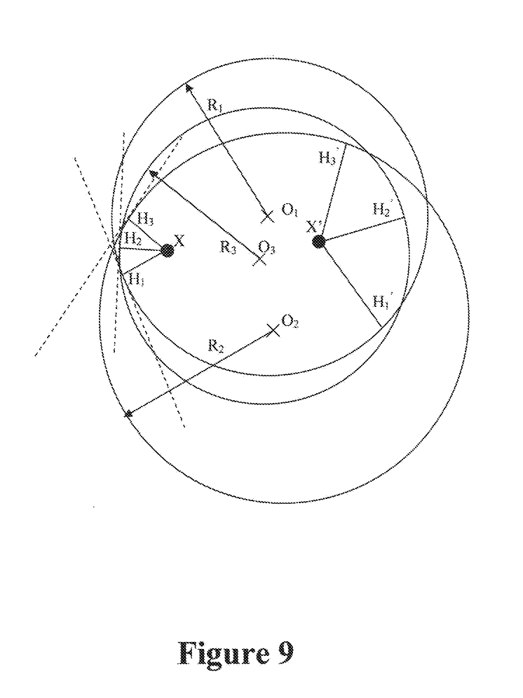

If the radio center is located outside of the polygon formed by RCKL (O₁, O₂, O₃), as shown in FIG. 8 (where L is the localization area in the OV (the overlap of the circles), X is the location of an object inside the area of localization, O1, O2 and O3 is RCKL position, R₁, R₂ and R₃ are measured distances, dR₁, dR₂, dR₃ are average overestimations for each RCKL that are determined experimentally), then, to determine the position, the geometric locus of a point that is equidistant from the circles is determined, pre-adjusting it for error. If there are several equidistant points X and X′ (with distances XH₁=XH₂=XH₃XH₁′=XH₂′=XH3′ to circles O₁, O₂, O₃, with centers O1, O2 and O3 in RCKL, and radii R1, R2 and R3 that are equal to measured distances), then, as shown in FIG. 9, the point X with the shortest modulo distance is selected.

The described methods of determining the location for the point that is outside of the polygon formed by RCKL can also be applied in the case where the object is inside a polygon for conditions, where reflections are negligible.

Changes and modifications of the described group of inventions, as well as additional applications of the invention's principles that are obvious to experts in this technical field are also part of the scope of this invention.

1. The method of the radio center localization by measuring the distances between the said radio center and radio centers with known locations (RCKL) by the signal propagation time between them that is characterized by the fact that in it
parameters of movement of the said radio center are measured,
radio signal strength from the said radio center is measured,
displacement of the radio center with the preset speed limit is calculated for the period of time between localization points,
accuracy of localization is calculated depending on the size of the overlapping area of circles with centers in these RCKL and radii that are equal to the measured distance between them and the said radio center,
these parameters of movement and change in the radio signal strength are compared with predefined threshold values, and the said displacement—with the said localization accuracy and
location is calculated while taking into account minimum distance measured over the whole period of immobility, during which these movement parameters and changes in the said strength are less than the said threshold values, and the said displacement is less than the said accuracy of localization.

2. The method according to claim 1 is characterized by the fact that it measures the distance by the method of symmetric double-sided two-way ranging

3. The method according to claim 1 is characterized by the fact that it measures the distance by RTT method.

4. The method according to claim 1 is characterized by the fact that it uses previously positioned radio centers as RCKL.

5. The method according to any one of the claims 1-4, characterized by the fact that it measures the distance to at least one RCKL.

6. The method according to any one of the claims 1-4, characterized by the fact that it measures the distance to at least three RCKL that are installed at a distance from each other.

7. The method according to any one of claims 1-4, characterized by the fact that in it, if the said location accuracy is below the preset value, the distance between the said radio center and additional RCKL is measured.

8. The method according to any one of the claims 1-4, characterized by the fact that it uses such number of RCKL that is sufficient to achieve the pre-specified accuracy of localization.

9. The method according to claim 1, characterized by the fact that the RCKL used in it are selected based on the radio signal strength.

10. The method according to claim 1, characterized by the fact that the RCKL to be used are selected based on the accuracy of localization.

11. Method per claim 1 that is characterized by the fact that the location is calculated as a geometric locus of an internal point of the overlapping area of circles with centers in these RCKL and radii that are equal to the measured distances between them and the said radio center.

12. Method per claim 11 that is characterized by the fact that the location is calculated as the geometric locus of an internal point equidistant from the boundaries of the said area.

13. Method per claim 11 that is characterized by the fact that the location is calculated as the geometric locus of an internal point that is a provisional center of the weight of the said area.

14. The method according to any one of claims 11-13 that is characterized by the fact that the said area is formed with distances that were pre-adjusted depending on the signal strength.

15. The method according to any one of claims 11-13 that is characterized by the fact that according to it, to calculate the location of the said circles overlap area, some pre-defined areas, where the said radio center cannot be located, were excluded.

16. The method according to claim 1, characterized by the fact that according to it, measurement of the said motion parameters is performed by a magnetometer, accelerometer, odometer, tachometer and/or speedometer.

17. The method according to claim 1, characterized by the fact that according to it, measurement of the said motion parameters is performed by the Doppler frequency shift of the radio signal.

18. The method according to claim 1, characterized by the fact that according to it, to determine the direction of radio signal propagation, the difference of phases of the radio signal from the radio center is measured.

19. The method according to claim 1 that is characterized by the fact that according to it, to measure the distance and strength, a single radio signal is used.

20. Radio center localization system containing:
radio centers with a known location (RCKL),
time meter (TM) for signal propagation between the RCKL and the said radio centers by signal propagation time between them,
distance calculator (DC) between the RCKL and the said radio center that is connected to the said DC,
location calculator (LC) of the said radio center taking into account the distances between the RCKL and the said radio center,
accuracy calculator (AC) of the said radio center locations, depending on the area of the overlapping circles with centers in RCKL and radii equal to the distances between the radio center and RCKL,
movement calculator (MC) of the said radio center with the preset speed limit for the period of time between consecutive localization points,
meter of movement parameters for the said radio center (MMPR)
meter of radio signal strength parameters (MS) of the said radio center,
first comparator (FC) connected to the MMPR and configured to compare changes in the input value with a predetermined threshold value,
second comparator (SC) connected to the MS and configured to compare changes in the input value with a predetermined threshold value,
third comparator (TC) connected to the MC and AC and configured to compare the input values to each other,
memory device (MD),
forth comparator (4C) connected to the DC and configured to compare changes in the input value with the MD value,
first logical calculator (FLC), with the option to compute the Boolean function “NOR”,
second logical calculator (SLC), with the option to compute the Boolean functions “AND”,
recording unit (RU) configured to record the distances between RCKL and the said radio center in the MD,
characterized by the fact that in it
FC, SC and TC outputs are connected to the FLC input, FLC output and 4C output are connected to the SLC input, and SLC output is connected to the RU.

21. The system according to paragraph 20 is characterized by the fact that it further contains a fifth comparator (5C) that has the ability to compare accuracy of the said localization with a predetermined threshold value, and the sixth comparator (6C) with the ability to compare influence of the RCKL on the said localization accuracy, as well as the control unit (CU) configured to activate as many RCKL as necessary to ensure the accuracy of localization above the said threshold.

22. The system according to paragraph 20 is characterized by the fact that in it at least two of the LC, DC, AC, MC, FLC, SLC, FC, SC, TC, 4C, RU, 5C, 6C, CU are arranged into a single integrated circuit.

23. The system according to any of paragraphs 20-22 is characterized by the fact that in it at least one of the LC, DC, AC, MC, FLC, SLC, FC, SC, TC, 4C, RU, 5C, 6C, CU was made on the basis of at least one general purpose processor, ASIC-processor, DSP-processor, programmable logic integrated circuit (PLIC) and/or electronic analog computing device.

24. The system according to any of paragraphs 20-22 is characterized by the fact that in it RCKL and LC, DC, AC, MC, FLC, SLC, FC, SC, TC, 4C, RU, 5C, 6C, CU are linked by a single wired and/or wireless network.

25. The system according to paragraph 20 is characterized by the fact that in it the MMPR is a magnetometer, accelerometer, odometer, tachometer and/or speedometer.

26. The system according to paragraph 20 is characterized by the fact that in it the MMPR is based on the meters of the Doppler shift.

27. Data processing unit for implementing the radio center localization method according to claim 1, containing the following:
telecommunications interface (TI) for receiving motion parameters of the said broadcasting center, parameters of the said radio center radio signal strength, and parameters of the distance between the said radio center and the radio center with known location (RCKL),
location calculator (LC) for the radio center within the parameters of the distance between the radio center and RCKL,
accuracy calculator (AC) of the said radio center locations, depending on the area of the overlapping circles with centers in RCKL and radii equal to the distances between the radio center and RCKL,
movement calculator (MC) of the said radio center with the preset speed limit for the period of time between consecutive localization points,
first comparator (FC) configured to compare the said parameters with predetermined threshold values,
second comparator (SC) configured to compare the said radio signal strength parameters with predetermined threshold values,
third comparator (TC) connected to the MC and AC and configured to compare the input values to each other,
memory device (MD),
forth comparator (4C) connected to the DC and configured to compare changes in the input value with the MD value,
first logical calculator (FLC), with the option to compute the Boolean function “NOR”,
second logical calculator (SLC), with the option to compute the Boolean functions “AND”,
recording unit (RU) configured to record the parameters of distances between RCKL and the said radio center in the MD,
characterized by the fact that according to it
FC, SC and TC outputs are connected to the FLC input, FLC output and 4C output are connected to the SLC input, and SLC output is connected to the RU.

28. The unit according to claim 27 that is characterized by the fact that in it at least two of the LC, DC, AC, MC, FLC, SLC, FC, SC, TC, 4C, and RU are arranged into a single integrated circuit.

29. The unit according to any one of the claim 27 or 28 that is characterized by the fact that in it at least one of the LC, DC, AC, MC, FLC, SLC, FC, SC, TC, 4C and RU was made on the basis of at least one general purpose processor, ASIC-processor, DSP-processor, programmable logic integrated circuit (PLIC) and/or electronic analog computing device.

30. The unit according to any of one of the claim 27 or 28 that is characterized by the fact that in it RCKL and LC, DC, AC, MC, FLC, SLC, FC, SC, TC, 4C and RU are linked by a single wired and/or wireless network.

31. The unit according to any of one of the claim 27 or 28 that is characterized by the fact that it further comprises distance calculator (DC) between RCKL and the said radio station.
